(19) United States
(12) Patent Application Publication
(10) Pub. No.: US 2010/0283771 A1
(43) Pub. Date: Nov. 11, 2010

(54) INFORMATION DETECTING DISPLAY DEVICE AND METHOD FOR DETECTING INFORMATION IN THE DISPLAY DEVICE

(75) Inventors: Hui-Sung LEE, Asan-si, (KR); Hyung-Guel KIM, Seongnam-si, (KR); Kyung-Hoon YOON, Hwaseong-si, (KR); Jae-Hyun CHO, Seoul, (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si, (KR)

(21) Appl. No.: 12/753,366

(22) Filed: Apr. 2, 2010

(30) Foreign Application Priority Data
May 6, 2009 (KR) 2009-0039161
Dec. 15, 2009 (KR) 2009-0124405

(51) Int. Cl. G06F 3/038; G09G 3/36

(52) U.S. Cl. 345/207; 345/88

(57) ABSTRACT

An information detecting display device includes an information detecting substrate having a photo-sensor and a switching substrate facing the information detectable substrate, wherein the information detectable substrate includes a first substrate, a plurality of photo-sensors arranged in a matrix on the first substrate and which generate sensing signals, a plurality of sensor scanning lines which transmit sensor scanning signals for controlling output of the sensing signals and a plurality of sensor signal lines which transmit the sensing signals in response to the sensor scanning signals, wherein at least two of the sensor scanning lines transmit substantially the substantially same sensor scanning signals simultaneously.

This application claims priority to Korean Patent Application No. 10-2009-0039161, filed on May 06, 2009, and Korean Patent Application No. 10-2009-0124405, filed on Dec. 15, 2009, all the benefits accruing therefrom under 35 U.S.C. §119, the contents of which in their entirety are herein incorporated by reference.

### BACKGROUND OF THE INVENTION

1. Field of the Invention

The present disclosure relates to an information detecting display device, in particular, a display device which is provided with a photo sensor, and a method for detecting information in the display device.

2. Description of the Related Art

A liquid crystal display (“LCD”) typically includes a lower substrate and an upper substrate provided with pixel electrodes and a common electrode respectively, and a liquid crystal layer interposed between the two substrates. The liquid crystal layer may have dielectric anisotropy. The pixel electrodes are typically arranged in a matrix and are connected to switching elements, such as thin film transistors (“TFT”), so as to be applied with data voltages. The common electrode is typically formed on an entire surface of the upper substrate and is applied with a common voltage. The pixel electrodes, the common electrode and the liquid crystal layer form a liquid crystal capacitor and the liquid crystal capacitor is a basic unit of a pixel along with the switching element connected thereto.

A display device which can detect information typically recognizes touch information or position information through a finger or a stylus input, e.g., a touch, so as to input information into the display device, e.g., to write a character, draw a picture, or activate an icon. Such a display device typically performs the information detection through detection of a resistance change or a photo-intensity change.

The display device detecting information via a resistance change includes a resistance change detecting device which comprises a plurality of resistance lines arranged in vertical and horizontal directions. The resistance lines of the plurality of resistance lines are contacted to each other by an exterior touch stimulus so the display device detects the change of the resistance and recognizes touch information or position information in a specific position corresponding to the location of the change of resistance. Alternatively, the display device including a device to detect a photo-intensity change includes a plurality of photo-sensors which are arranged in a matrix. The plurality of photo-sensors generates signals depending on the photo-intensity received thereby, respectively, so the display device detects the change of the photo-intensity in a specific position.

The resistance change detecting device can be formed on a plurality of types and sizes of displays so as to beneficially be able to be combined easily with other displays. The photo-sensors can be formed inside other displays so as to have a benefit of being able to be combined with other displays without an increase of thickness and a reduction of illumination whereas the resistance change detecting device increases the thickness and reduces the illumination of other displays to be combined therewith.

Thus, it has been studied that the display device including an information detecting device recognizes touch information or position information according to the photo-intensity change and photo-sensors for detecting the photo-intensity change are formed inside display device. However, the display device having photo-sensors is affected by other elements of the display device since the photo-sensors are formed inside the display device, e.g., the photo sensors may be inadvertently triggered due to electromagnetic interference, etc. As the display device increases in size, a technology for touch information or position information to be rapidly processed is desired.

### BRIEF SUMMARY OF THE INVENTION

The present invention provides an information detecting display device wherein electrical affection between photo-sensors and switching elements is reduced and a speed for recognizing information is improved.

The present invention provides an information detecting display device including an information detecting substrate having a photo-sensor and a switching substrate facing the information detecting substrate.

The present invention also provides a method for detecting information in the display device.

An exemplary embodiment of an information detecting display device includes; an information detecting substrate including; a first substrate, a plurality of photo-sensors arranged in a matrix on the first substrate, wherein the photo-sensors generate a plurality of sensing signals, a plurality of sensor scanning lines which transmit a plurality of sensor scanning signals which control an output of the plurality of sensing signals, and a plurality of sensor signal lines which transmit the sensing signals in response to the plurality of sensor scanning signals, wherein at least two of the plurality of sensor scanning lines each transmit a substantially similar sensor scanning signal simultaneously, and a switching substrate including; a second substrate, a plurality of pixel electrodes arranged in a matrix on the second substrate, a plurality of switching elements electrically connected to the plurality of pixel electrodes an a plurality of switch scanning lines, and a plurality of switch signal lines electrically connected to the plurality of switching elements.

According to an exemplary embodiment of the information detecting display device, at least two of the plurality of sensor scanning lines are electrically connected to each other.

Another exemplary embodiment of the information detecting display device further includes a first sensor scanning part and a second sensor scanning part, each of which are electrically connected to a first side of the first substrate and which transmit the plurality of sensor scanning signals to the plurality of sensor scanning lines, a first sensor reader part electrically connected to a second side of the first substrate and which receives first sensing signals from first photo-sensors of the plurality of photo-sensors, the first photo-sensors being electrically connected to the first sensor scanning part, and a second sensor reader part electrically connected to a third side of the first substrate and which receives second sensing signals from second photo-sensors of the plurality of photo-sensors, the second photo-sensors being electrically connected to the second sensor scanning part. In another exemplary embodiment, the first sensor scanning part and the second sensor scanning part may substantially simultaneously transmit the substantially same sensor scanning signals to the plurality of sensor scanning lines.

In one exemplary embodiment, the plurality of switch scanning lines and the plurality of switch signal lines may face and overlap the plurality of sensor scanning lines and the plurality of sensor signal lines, respectively. In one exemplary embodiment, a number of the plurality of sensor scanning lines may be smaller than a number of the plurality of switch scanning lines or, in another exemplary embodiment, a number of the plurality of sensor signal lines may be is smaller than a number of the plurality of switch signal lines.

Exemplary embodiments include configurations wherein the switching substrate further includes a plurality of color filter layers and a plurality of opaque layers disposed between the plurality of color filter layers, wherein the plurality of opaque layer overlaps with at least one of the plurality of sensor signal lines. In one exemplary embodiment the information detecting substrate further includes a common electrode which generates electric fields along with the plurality of pixel electrodes. In another exemplary embodiment the switching substrate further includes a counter electrode which generates an electric field along with one of the plurality of pixel electrodes, wherein at least one of the plurality of pixel electrodes and the counter electrode is rod type electrode.

Still another exemplary embodiment of the information detecting display device includes an information detecting substrate and a switching substrate. The information detecting substrate includes a first substrate, a plurality of first and second groups of photo-sensors, a first sensor scanning part, a second sensor scanning part and a sensor reader part. The first and second groups of photo-sensors are arranged in a matrix on the first substrate, and the first and second groups of photo-sensors respectively generate a plurality of first, second, third and fourth sensing signals. The first sensor scanning part is disposed at a first portion of a first side of the first substrate and transmits a plurality of first sensor scanning signals to the first group of photo-sensors via a plurality of first sensor scanning lines. The second sensor scanning part is disposed at a second portion of the first side of the first substrate and transmits a plurality of second sensor scanning signals to the second group of photo-sensors via a plurality of second sensor scanning lines. The second portion is adjacent to the first portion. The sensor reader part receives the first, second, third and fourth sensing signals from the photo-sensors via a plurality of first, second, third and fourth sensor signal lines. The switching substrate includes a plurality of pixel units.

The sensor reader part may include first and second sensor reader parts. The first sensor reader part may be disposed at a second side of the first substrate and may receive the first and second sensing signals from the first group of photo-sensors via the first and second sensor signal lines. The second sensor reader part may be disposed at a third side of the first substrate and may receive the third and fourth sensing signals from the second group of photo-sensors via the third and fourth sensor signal lines. The third side may be opposite to the second side.

The sensor reader part may include first, second, third and fourth sensor reader parts. The first sensor reader part may be disposed at a first portion of a second side of the first substrate and may receive the first sensing signals from a first sub group of the first group of photo-sensors via the first sensor signal lines. The second sensor reader part may be disposed at a second portion of the second side of the first substrate and may receive the second sensing signals from a second sub group of the first group of photo-sensors via the second sensor signal lines. The third sensor reader part may be disposed at a first portion of a third side of the first substrate and may receive the third sensing signals from a first sub group of the second group of photo-sensors via the third sensor signal lines. The fourth sensor reader part may be disposed at a second portion of the third side of the first substrate and may receive the fourth sensing signals from a second sub group of the second group of photo-sensors via the fourth sensor signal lines. The second portion of the second side may be adjacent to the first portion of the second side, the second portion of the third side may be adjacent to the first portion of the third side, and the second side may be opposite to the third side.

Exemplary embodiment of a method for detecting information in a display device includes generating a plurality of sensing signals by a plurality of photo-sensors arranged in a matrix on a first substrate. A plurality of sensor scanning signals is transmitted from a sensor scanning part to the photo-sensors via a plurality of sensor scanning lines. At least two of the sensor scanning lines transmit a substantially similar sensor scanning signal simultaneously. The sensing signals are transmitted from the photo-sensors to a sensor reader part via a plurality of sensor signal lines in response to the sensor scanning signals.

The sensing signals are processed by the sensor reader part to provide processed sensing signals to a controller. A position of the sensing signals is determined based on the sensor scanning signals and the sensing signals.

The present invention is described with respect to the following exemplary embodiments and combination thereof and principles of the invention aren't limited to the specifically described exemplary embodiments.

### BRIEF DESCRIPTION OF THE DRAWINGS

The accompanying drawings briefly described below illustrate exemplary is embodiments of the present invention and, together with the description, serve to explain the principles of the present invention, in which:

FIG. 1 is a block diagram of a first exemplary embodiment of an information detecting substrate;

FIG. 2 is a block diagram of a second exemplary embodiment of an information detecting substrate;

FIG. 3 is a block diagram of a third exemplary embodiment of an information detecting substrate;

FIG. 4 is an equivalent circuit diagram of an exemplary embodiment of a photo-sensor;

FIG. 5 is a block diagram of a first exemplary embodiment of a switching substrate;

FIG. 6 is a top perspective view of an exemplary embodiment of the information detecting substrate and the switching substrate;

FIG. 7 is a cross-sectional view of the first exemplary embodiment of an information detecting display device;

FIG. 8 is a cross-sectional view of the second exemplary embodiment of an information detecting display device; and

FIG. 9 is a cross-sectional view of the third exemplary embodiment of an information detecting display device.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

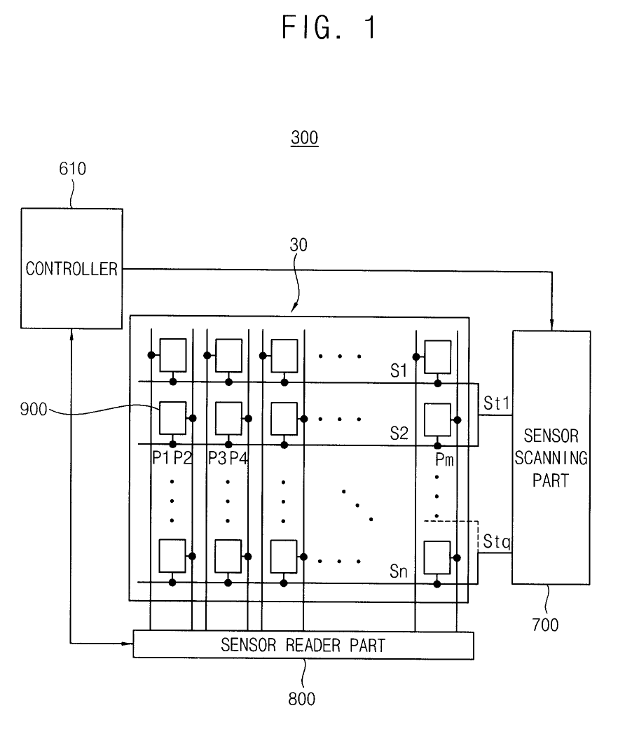

FIGS. 1 to 3 are block diagrams of exemplary embodiments of an information detecting substrate.

Referring to FIG. 1, an information detecting substrate 300 as one exemplary embodiment of this invention comprises signal lines S (e.g., S1-Sn) and P (e.g., P1-Pm), photo-sensor 900, sensor scanning part 700, sensor reader part 800, and controller 610 for controlling the sensor scanning part 700 and sensor reader part 800.

The signal lines S (S1-Sn) and P (P1-Pm) include a plurality of sensor scanning lines S (S1-Sn) to transmit sensor scanning signals and a plurality of sensor signal lines P (P1-Pm) to transmit sensing signals. In the present exemplary embodiment, the sensor scanning lines S (S1-Sn) are substantially extended in a row direction and substantially in parallel to each other and the sensor signal lines P (P1-Pm) are substantially extended in a column direction and substantially in parallel to each other.

The controller 610 controls sensor scanning signals to be output from the sensor scanning part 700 and receives detecting signals to be processed in the sensor reader part 800. In one exemplary embodiment, the controller 610 may transmit the detecting signals to another processor. Furthermore, the controller 610 can initialize or reset the sensor scanning part 700 and the sensor reader part 800.

The information detecting substrate 300 of this invention can detect information by a method to be explained in more detail below.

Corresponding to the sensor scanning signals output one after another, e.g., sequentially, from sensor scanning part 700 to the sensor scanning lines S (S1-Sn), the sensing signals from the photo sensors 900 are transmitted to the sensor reader part 800 by the sensor signal lines P (P1-Pm). The sensor reader part 800 processes the transmitted sensing signals into a detecting signal and transmits the detecting signal to the controller 610. The controller 610, or a processor (not shown) connected to the controller 610, determines the position of an exterior stimulus based on the output sensor scanning signal and the detecting signal.

In the present exemplary embodiment, the information detecting substrate 300 further comprises connection parts St (e.g., ST1-STq) to electrically connect neighboring sensor scanning lines S so that at least 2 of sensor scanning lines S are simultaneously applied with substantially a same sensor scanning signal. In such an exemplary embodiment, the number of the sensor scanning lines S is larger than the number of output terminals of the sensor scanning part 700 to apply the sensor scanning signals.

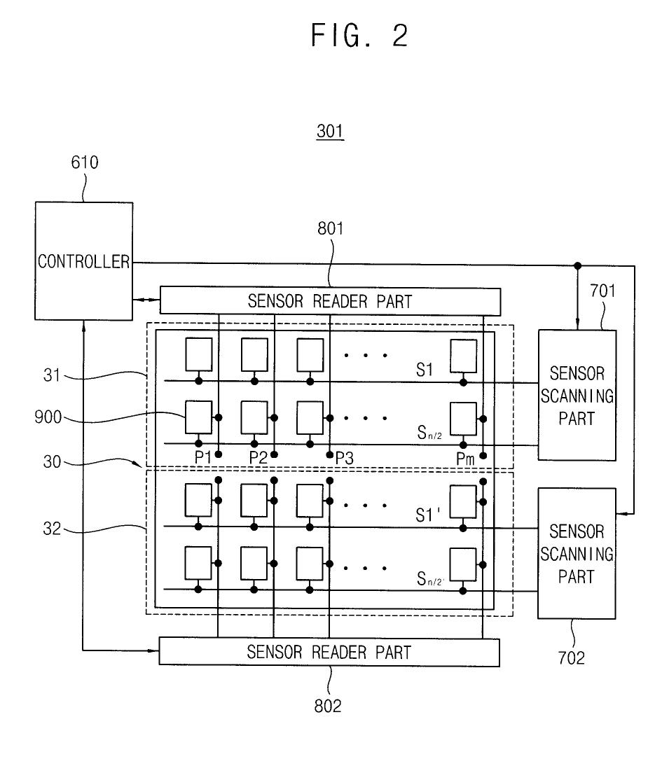

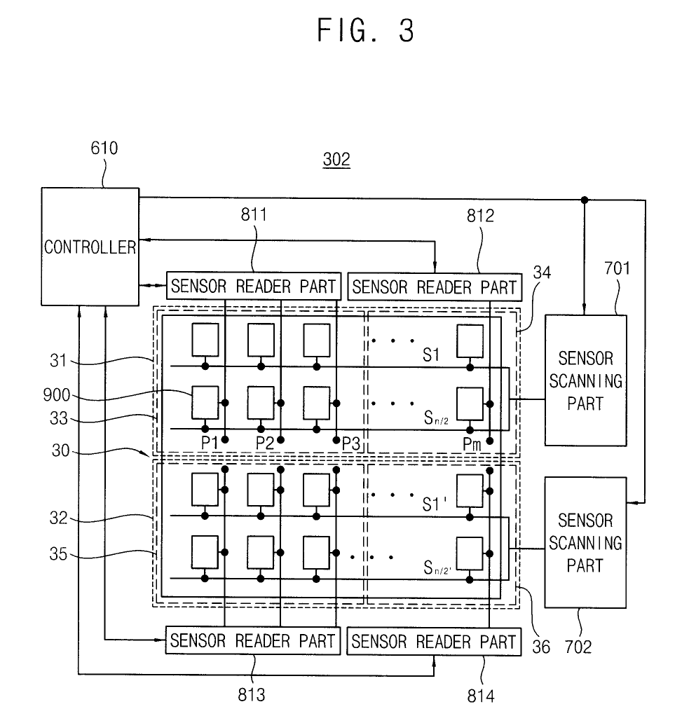

Exemplary embodiments include configurations wherein the sensor scanning part 700 may be provided with sub sensor scanning parts and the sensor reader part 800 also may be provided with sub sensor reader parts, as will be described in more detail with respect to FIGS. 2 and 3.

As stated above, position information of an exterior stimulus can be recognized rapidly by substantially simultaneously applying substantially the same sensor scanning signals to at least 2 of the plurality of sensor scanning lines. For example, in an exemplary embodiment wherein two neighboring sensor scanning lines are connected to each other at a second substrate 30 to be arranged with n by m photo sensors, whole position information of the second substrate 30 can be recognized at the rate of two times faster than when the sensor scanning lines are not connected to each other. In an exemplary embodiment, when neighboring two sensor scanning lines are connected to each other, 2×m of sensor signal lines are used. When neighboring r sensor scanning lines are connected to each other at the second substrate 30 to be arranged with nby m photo sensors, whole position information of the second substrate 30 can be recognized at the rate of r times. However r×m sensor signal lines are then used. The n, m and r characters of the above explanation indicate integers more than 2 and the X character indicates a multiplication symbol. Referring to FIG. 2, another exemplary embodiment of an information detecting substrate 301 comprises a plurality of photo sensors 900 arranged in a matrix, wherein the plurality of photo sensors 900 are divided into two groups and each of groups is individually operated. In other words, first and second groups of the photo sensors 900 are arranged at an upper portion 31 and a lower portion 32 of the second substrate 30, respectively. First and second sensor scanning parts 701 and 702 are electrically connected to one side of the second substrate 30, wherein the first sensor scanning part 701 applies first sensor scanning signals to the first group of photo sensors 900 and the second sensor scanning part 702 applies second sensor scanning signals to the second group of photo sensors 900. Specifically, the first sensor scanning part 701 applies first sensor scanning signals to sensor scanning lines S1-Sn/2 and the is second sensor scanning part 702 applies second sensor scanning signals to sensor scanning lines S1′-Sn/2′. In the present exemplary embodiment, the first sensor scanning signals and the second sensor scanning signals are substantially similar and are simultaneously applied to the sensor scanning lines S1-Sn, respectively. For example, when a first sensor scanning signal is applied to sensor scanning line S1, a substantially similar second sensor scanning signal is applied to sensor scanning line S1′.

The sensor signal lines P (P1-Pm) comprise a first sensor signal line and a second sensor signal line, wherein the first and second sensor signal lines are electrically connected to the first and second group of the photo sensors 900 and first and second sensor reader parts 801 and 802. In the present exemplary embodiment, the first and second sensor signal lines are isolated from each other.

Furthermore, exemplary embodiments include configurations wherein the first and second sensor scanning parts 701 and 702 may be provided with first and second sub-sensor scanning parts, respectively and the first and second sensor reader parts 801 and 802 also may be provided with first and second sub-sensor reader parts, respectively.

As described above, position information of an exterior stimulus can be recognized rapidly by simultaneously applying the substantially same sensor scanning signals to the sensor scanning lines from the first and second sensor scanning parts 701 and 702, respectively. For example, when the first and second sensor scanning parts 701 and 702 substantially simultaneously apply the substantially same sensor scanning signals to the sensor scanning lines, respectively, whole position information of the second substrate 30 can be recognized twice as rapidly as an embodiment wherein the sensor scanning lines are applied from the first sensor scanning parts first and then the second scanning parts one after another.

The exemplary embodiment of an information detecting substrate of FIG. 2 is substantially similar to the exemplary embodiment described with respect to

FIG. 1 except for the above-described differences.

Referring to FIG. 3 another exemplary embodiment of an information detecting substrate 302 of this invention comprises a plurality of photo sensors 900 arranged in a matrix, wherein the plurality of photo sensors 900 are divided into first and second groups and each of the first and second groups is individually operated similar to that described with respect to FIG. 2. Furthermore the first and second groups of the photo sensors 900 are divided into first and second sub groups, respectively. The first sub group of the first group of the photo sensors is arranged at an upper-left portion 33, the second sub group of the first group of the photo sensors is arranged at an upper-right portion 34. The first sub group of the second group of the photo sensors is arranged at a lower-left portion 35, the second sub group of the second group of the photo sensors is arranged at a lower-right portion 36. And the first and second sub groups of the first group and the first and second sub groups of the second group are connected to four sensor reader parts 811, 812, 813 and 814, respectively. For example, the first sub group of the first group is connected to a first sensor reader part 811, the second sub group of the first group is connected to a second sensor reader part 812, the first sub group of the second group is connected to a third sensor reader part 813, and the second sub group of the second group is connected to a fourth sensor reader part 814. In one exemplary embodiment, each of the first, second, third and fourth sensor reader parts 811, 812, 813 and 814 is operated individually.

The exemplary embodiment of an information detecting substrate of FIG. 3 is substantially similar to the exemplary embodiment described with respect to

FIGS. 1 and 2 except for the above-described differences.

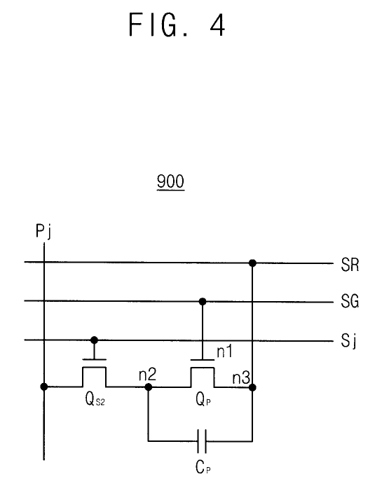

FIG. 4 is an equivalent circuit diagram of an exemplary embodiment of a photo-sensor 900.

Referring to FIG. 4, each of the photo sensors 900 comprises a sensor element Qp connected to sensor lines SR and SG, a switching element Qs2 connected to signal lines Sj and Pj, and a sensor capacitor Cp. Alternative exemplary embodiments include configurations wherein the sensor capacitor Cp can be omitted. Exemplary embodiments include configurations wherein the sensor element Qp and the switching element Qs2 may be a thin film transistor having 3 terminals.

A control terminal n1 of the sensor element Qp is connected to a sensor gate line SG, an output terminal n2 of the sensor element Qp is connected to the sensor capacitor Cp and the switching element Qs2, and an input terminal n3 of the sensor element Qp is connected to a sensor reference line SR. The sensor capacitor Cp is connected to the output terminal n2 and the sensor reference line SR. A control terminal of the switching element Qs2 is connected to a sensor scanning line Sj, an output terminal of the switching element Qs2 is connected to a sensor signal line Pj, and an input terminal of the switching element Qs2 is connected to the sensor element Qp and the sensor capacitor Cp.

In one exemplary embodiment, the sensor element Qp includes an amorphous silicon layer and generates a photo current when the amorphous silicon is illuminated. The photo current may flow toward the sensor capacitor Cp and the switching element Qs2 or opposite them, based on a reference voltage applied to the sensor reference line SR. The sensor capacitor Cp sustains a voltage corresponding to charges caused by the photo current.

The switching element Qs2 transmits a sensing signal stored at the sensor capacitor Cp or caused by the photo current to the sensor signal line Pj when a sensor scanning signal is applied to the sensor scanning line Sj so that the switching element Qs2 is turned on.

Furthermore, the sensor element Qp can be initialized by applying a turn-on signal to the sensor gate line SG, periodically. During an initializing period, the sensor reference line SR can be applied with a voltage to be changed from the specific voltage.

The photo-senor 900 is operated as follows. Before the photo-senor 900 is operated, the following conditions are necessary. For example, a voltage difference between the output and input terminals n2 and n3 of the sensor element Qp is generated. A voltage of the sensor gate line SG is lower than that of the sensor reference line SR, which means that the sensor element Qp is in an Off-state. In addition, a voltage of the sensor scanning line Sj is lower than that of the output terminal n2, which means that the switching element Qs2 is in the Off-state.

Then, the photo-sensor 900 operates as follows. A photon reaches the sensor element Qp which is in the Off-state, and then an exciton is generated in the sensor element Qp. Since the voltage of the output terminal n2 is higher than that of the input terminal n3, the current flows from the output terminal n2 to the input terminal n3. A positive charge charged to the sensor capacitor Cp flows from the output terminal n2 to the input terminal n3. Quantity of electric charge is decreased due to the light, and thus the voltage of the output terminal n2 is decreased.

The switching element Qs2 operates as follows. After a predetermined period, the switching element Qs2 is turned on. For example, the voltage of the sensor scanning line Sj is higher than that of the output terminal n2. The positive charge flows through the signal line Pj. The positive charge reaches the sensor capacitor Cp through the switching element Qs2. Thus, the sensor capacitor Cp is charged.

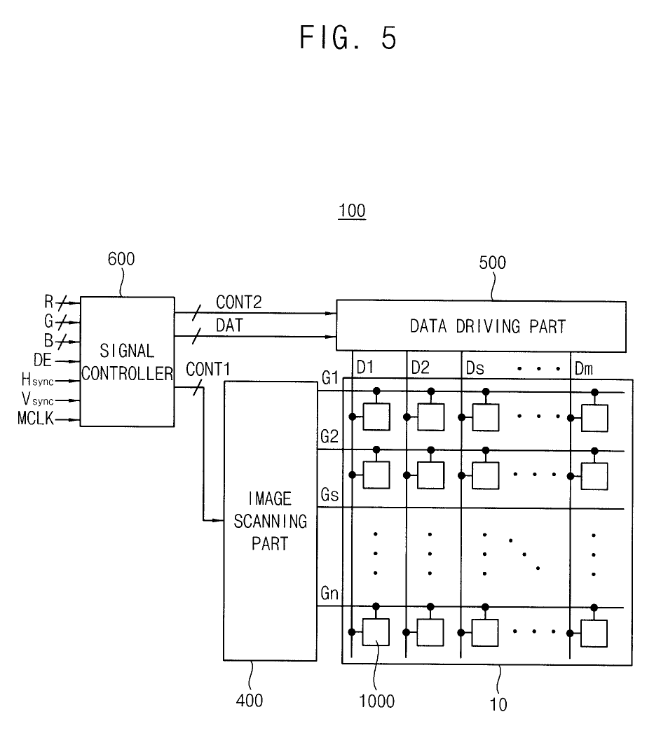

FIG. 5 is a block diagram of a first exemplary embodiment of a switching substrate 100. FIG. 5 is a block diagram of a switching substrate 100 of a liquid crystal display (“LCD”) but the present invention is not limited thereto. For example, alternative types of display devices may also be used such as an organic light emitting diode (“OLED”) display, a plasma display, etc.

Referring to FIG. 5, the switching substrate 100 comprises signal lines (G: G1-Gn, D: D1-Dm), pixel units 1000, an image scanning part 400, a data driving part 500 and a signal controller 600 for controlling the image scanning part 400 and the data driving part 500.

The signal lines G (G1-Gn) and D (D1-Dm) comprises switch scanning lines G (G1-Gn) which transmit switch scanning signals and switch signal lines D (D1-Dm) which transmit image data signals. Although the switch scanning lines G (G1-Gn) and the sensor scanning lines S (S1-Sn) of the exemplary embodiments illustrated in FIGS. 1 to 3 are formed on first and second substrates 10 and 30 different from each other, both scanning lines G (G1-Gn) and S (S1-Sn) extend substantially in a row direction and are substantially parallel to each other. Although the switch signal lines D (D1-Dm) and the sensor signal lines P (P1-Pm) of the exemplary embodiments illustrated in FIGS. 1 to 3 are also formed on the first and second substrates 10 and 30, both signal lines D (D1-Dm) and P (P1-Pm) extend in substantially a column direction and are substantially parallel to each other.

The signal controller 600 receives input image signals (e.g., R, G and B input signals in a color display) and input control signals to control display thereof from an exterior graphic controller. For example, in an exemplary embodiment the input control signals comprise a vertical sync signal (Vsync), a horizontal sync signal (Hsync), main clock (MCLK) signal, a data enable signal (DE) and various other similar signals. The signal controller 600 processes image signals (R, G and B signals), based on the input image signals (R, G and B input signals) and the input control signals, and generates an image scanning control signal (CONT1), a data driving control signal (CONT2) and various other similar signals. The image scanning control signal (CONT1) is transmitted to the image scanning part 400 and the data driving control signal (CONT2) is transmitted to the data driving part 500.

One of the pixel units 1000 comprises at least one switching element and a pixel electrode connected to the switching element. When the switching scanning line G is applied with on-voltage (Von), the switching elements connected thereto is turned on and then the pixel electrodes connected to the respective switching elements is charged, based on the image data signal applied to the switching elements via the respective switch signal lines D.

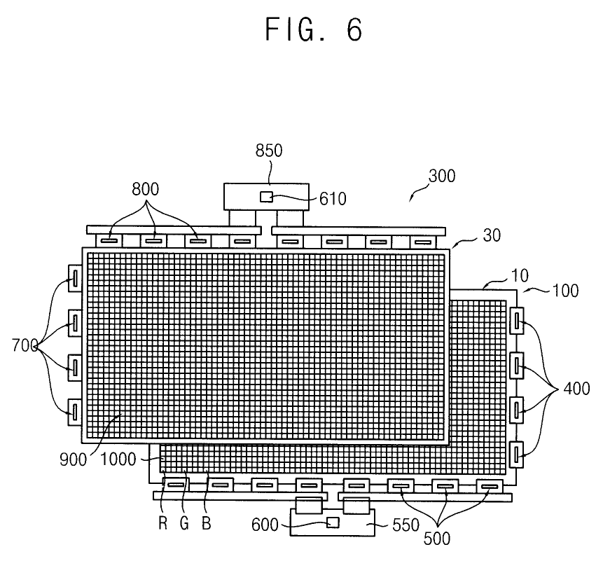

FIG. 6 is a top perspective view of exemplary embodiments of the information detecting substrate 300 and the switching substrate 100.

Referring to FIG. 6, the information detecting substrate 300 and the switching substrate 100 are arranged to face each other.

The switching substrate 100 comprises flexible films electrically connected to sides of the first substrate 10. The image scanning part 400 or the data driving part 500 are formed on each of the flexible films. The flexible films are electrically connected to the switch signal lines D and the switch scanning lines G of the first substrate 10, respectively. The signal controller 600 is arranged on a first main circuit board 550. Alternative exemplary embodiments include configurations wherein a portion or all of the image scanning part 400 may be formed on the first substrate 10.

In an exemplary embodiment wherein the display is a color display, the pixel unit 1000 of the switching substrate 100 may comprise red, blue and green color filter layers. The color filter layers may be formed on the detecting substrate 300.

The information detecting substrate 300 also comprises flexible films electrically connected to sides of the second substrate 30 similar to that described with respect to the switching substrate 100. The sensor scanning part 700 or the sensor reader part 800 are formed on flexible films. The flexible films are electrically connected to the sensor signal lines P and the sensor scanning lines S of the second substrate 30, respectively. The controller 610 is arranged on a second main circuit board 850. Alternative exemplary embodiments include configurations wherein a portion or all of the sensor scanning part 700 may be formed on the second substrate 30.

Exemplary embodiments include configurations wherein the first and second main circuit board 550 and 850 are arranged substantially opposite to each other. Alternative exemplary embodiments include configurations wherein the second main circuit board 850 can be omitted and the sensor reader parts 800 and the sensor scanning parts 700 may be electrically connected to the first main circuit board 550, when the controller 610 is formed on the first main circuit board 550 or combined with the signal controller 600.

In one exemplary embodiment, the switch signal lines D and switch scanning lines G of the first substrate 10 and the sensor signal lines P and sensor scanning lines S of the second substrate 30 are arranged on inside surfaces of the first and second substrates 10 and 30 facing each other. Furthermore, exemplary embodiments include configurations wherein the sensor scanning lines S and sensor signal lines P can be partly overlapped with the switch scanning lines G and switch signal lines D. In one exemplary embodiment, the number of the sensor scanning lines S is smaller than that of the switch scanning lines G and the number of the sensor signal lines P is smaller than that of the switch signal lines D.

Exemplary embodiments include configurations wherein a backlight may be positioned under the first substrate 10 of the switching substrate 100 and a polarizer film and/or a compensation film are attached on the second substrate 30 of the information detecting substrate 300.

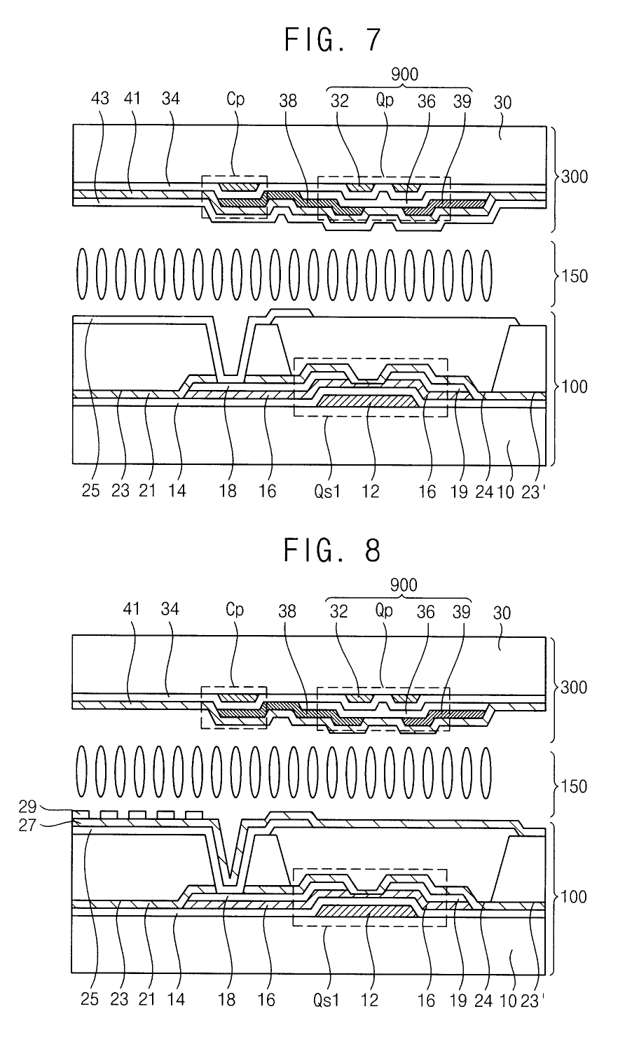

FIGS. 7 to 9 are cross-sectional views of exemplary embodiments of information detecting display device.

Referring to FIG. 7, the switching substrate 100 comprises a switching element Qs1 having three terminals on the first substrate 10 and an organic insulation layer 23 formed around on the switching element Qs1. The organic insulation layer 23 has a contact hole which exposes one terminal of the switching element Qs1 and a pixel electrode 25 is formed on the organic insulation layer 23 and is electrically connected to the switching element Qs1 through the contact hole.

In one exemplary embodiment the organic insulation layer 23 may be a color filter layer, e.g., a color filter layer of red, blue or green. An opaque layer 24 may be arranged between adjacent (and possibly different) color filter layers 23 and 23′. Exemplary embodiments include configurations wherein the opaque layer 24 is positioned on the switching element Qs1.

The information detecting substrate 300 comprises a photo sensor 900 on the second substrate 30 and a common electrode 43. A sensor element Qp and a switching element Qs2 (not shown) of the photo sensor 900 are a three-terminal device, similar to the switching element Qs1. However, exemplary embodiments of a sensor element Qp may have a gate electrode 32 (one terminal of the three-terminal device) to be entirely or semi-transparent, or the gate electrode 32 may include portions that are separated apart from each other, but to be applied with the same voltage, thereby allowing an exterior light to be able to illuminate the sensor element Qp. In one exemplary embodiment, the photo sensor 900 of the information detection substrate 300 may overlap the switching element Qs1 of the switching substrate 100 or the opaque layer 24.

Both the switching element Qs1 and sensor element Qp comprise gate electrodes 12 and 32, gate insulation layers 14 and 34, semiconductor layers 16 and 36, source/drain electrode 18 to 19 and 38 to 39 and protective layer 21 and 41, respectively. The protective layer 21 and 41 are in direct contact with the semiconductor layers 16 and 36 to cover channel portions and be positioned on the source/drain electrode 18 to 19 and 38 to 39. Each of the gate, source and drain electrodes is one of three terminals of the three-terminal devices.

The information detecting display device is provided with a liquid crystal layer 150 interposed between the first substrate 10 and the second substrate 30.

Referring to FIG. 8, the switching substrate 100 further comprises a counter electrode 29 disposed thereon which generates an electric field along with the pixel electrode 25. However, in the present exemplary embodiment the pixel electrode 25 may be a single electrode layer and the counter electrode 29 may be rod type electrodes. Alternative exemplary embodiments include is configurations wherein the pixel electrode 25 may be a rod type electrode and the counter electrode 29 may be a single electrode layer, wherein the rod type electrodes are formed on the counter electrode (not shown).

The exemplary embodiment of FIG. 8 is substantially similar to the exemplary embodiment described with respect to FIG. 7 except for the above-described differences.

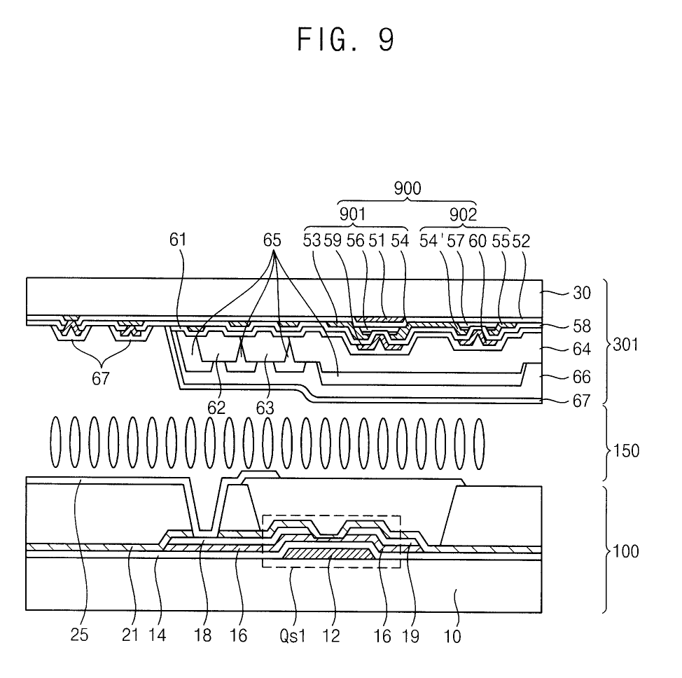

FIG. 9 is a cross-sectional view of the third exemplary embodiment of an information detecting display device.

The information detecting display device according to the present exemplary embodiment is substantially same as the information detecting display device according to the previous exemplary embodiment in FIGS. 7 and 8 except for an information detecting substrate 301. Thus, any further repetitive explanation concerning the information detecting display device will be omitted.

Referring to FIG. 9, the photo-sensor 900 includes first and second sensing elements 901 and 902 formed on the second substrate 30.

The first sensing element 901 includes a first gate electrode 51, a semiconductor layer 56, source and drain electrodes 54 and 53, and a second gate electrode 59. For example, the first sensing element 901 includes a double-layered gate electrode structure.

The second sensing element 902 includes a semiconductor layer 57, source and drain electrodes 55 and 54′, and a gate electrode 60. For example, the second sensing element 902 includes a top gate electrode structure.

The first gate electrode 51 is formed on the second substrate 30. A first gate insulating layer 52 is entirely formed on the second substrate 30 on which the first gate electrode 51 is formed. Semiconductor layers 56 and 57 are formed on the first gate insulating layer 52 by a predetermined distance. The source and drain electrodes 54 and 53 of the first sensing element 901 are formed on the first gate insulating layer 52 on which the semiconductor layer 56 is formed. In addition, the source and drain electrodes 55 and 54′ of the second sensing element 902 are formed on the first gate insulating layer 52 on which the semiconductor layer 57 is formed. A protective layer 58 is entirely formed on the first gate insulating layer 52 on which the source and drain electrodes 53, 54, 54′ and 55 are formed. The second gate electrode 59 of the first sensing element 901 is formed on the protective layer 58 in an area where the semiconductor layer 56 is formed, and the gate electrode 60 of the second sensing element 902 is formed on the protective layer 58 in an area where the semiconductor layer 57 is formed. A second gate insulating layer 61 is formed on the protective layer 58 on which the second gate electrode 59 and the gate electrode 60 are formed.

Color filters 62, 63 and 64 are formed on the second gate insulating layer 61. The color filters may include red, green and blue color filters. A black matrix 65 is formed at a boundary area between the color filters 62, 63 and 64, and is formed in an area where the photo-sensor 900 is formed. An organic layer 66 is formed on the color filters 62, 63 and 64 and the black matrix 65. A common electrode 67 is formed on the organic layer 66.

Alternatively, although not shown in the figure, the color filters 62, 63 and 64 may be formed over the first substrate 10 on which the switching element Qs1 is formed.

According to an exemplary embodiment of the present invention, since the lower substrate has substantially the same parasitic capacitances between adjacent pixel electrodes and a data line, a stripe defect that occurs because of the difference in parasitic capacitances is able to be reduced. While the invention has been shown and described with reference to exemplary embodiments thereof, it will be understood by those skilled in the art that various changes in form and details may be made therein without departing from the spirit and scope of the invention as defined by the appended claims.

What is claimed is:

1. An information detecting display device comprising:
an information detecting substrate comprising:
a first substrate;
a plurality of photo-sensors arranged in a matrix on the first substrate, wherein the photo-sensors generate a plurality of sensing signals;
a plurality of sensor scanning lines which transmits a plurality of sensor scanning signals which controls an output of the plurality of sensing signals; and
a plurality of sensor signal lines which transmits the sensing signals in response to the plurality of sensor scanning signals,
wherein at least two of the plurality of sensor scanning lines transmit a substantially similar sensor scanning signal simultaneously; and
a switching substrate comprising:
a second substrate;
a plurality of pixel electrodes arranged in a matrix on the second substrate;
a plurality of switching elements electrically connected to the plurality of pixel electrodes and a plurality of switch scanning lines; and
a plurality of switch signal lines electrically connected to the plurality of switching elements.

2. The information detecting display device of claim 1, wherein the plurality of switch scanning lines and the plurality of switch signal lines face and overlap the plurality of sensor scanning lines and the plurality of sensor signal lines, respectively.

3. The information detecting display device of claim 2, wherein a number of the plurality of sensor scanning lines is smaller than a number of the plurality of switch scanning lines.

4. The information detecting display device of claim 2, wherein a number of the plurality of sensor signal lines is smaller than a number of the plurality of switch signal lines.

5. The information detecting display device of claim 1, wherein the switching substrate further comprises a plurality of color filter layers.

6. The information detecting display device of claim 5, wherein the switching substrate further comprises a plurality of opaque layers disposed between the plurality of color filter layers, the opaque layers overlapping the plurality of sensor signal lines.

7. The information detecting display device of claim 6, wherein the information detecting substrate further comprises a common electrode which generates an electric field along with the plurality of pixel electrodes.

8. The information detecting display device of claim 1, wherein at least two of the plurality of sensor scanning lines are electrically connected to each other.

9. The information detecting display device of claim 1, wherein the information detecting substrate further comprises:
a first sensor scanning part and a second sensor scanning part, each of which are electrically connected to a first side of the first substrate and which transmit the plurality of sensor scanning signals to the plurality of sensor scanning lines;
a first sensor reader part electrically connected to a second side of the first substrate and which receives first sensing signals from first photo-sensors of the plurality of photo-sensors, the first photo-sensors being electrically connected to the first sensor scanning part; and
a second sensor reader part electrically connected to a third side of the first substrate and which receives second sensing signals from second photo-sensors of the plurality of photo-sensors, the second photo-sensors being electrically connected to the second sensor scanning part.

10. The information detecting display device of claim 9, wherein the first sensor scanning part and the second sensor scanning part substantially simultaneously transmit the substantially same sensor scanning signals to the plurality of sensor scanning lines.

11. The information detecting display device of claim 10, wherein the plurality of switch scanning lines and the plurality of switch signal lines face and overlap the plurality of sensor scanning lines and the plurality of sensor signal lines, respectively.

12. The information detecting display device of claim 11, wherein a number of the plurality of sensor scanning lines is smaller than a number of the plurality of switch scanning lines.

13. The information detecting display device of claim 11, wherein a number of the plurality of sensor signal lines is smaller than a number of the plurality of switch signal lines.

14. The information detecting display device of claim 10, wherein the switching substrate further comprises a plurality of color filter layers.

15. The information detecting display device of claim 14, wherein the switching substrate further comprises a plurality of opaque layers disposed between the plurality of color filter layers, the plurality of opaque layers overlapping the plurality of sensor signal lines.

16. The information detecting display device of claim 15, wherein the information detecting substrate further comprises a common electrode which generates electric fields along with the plurality of pixel electrodes.

17. An information detecting display device comprising:
an information detecting substrate comprising:
a first substrate;
a plurality of first and second groups of photo-sensors arranged in a matrix on the first substrate, the first and second groups of photo-sensors respectively generating a plurality of first, second, third and fourth sensing signals;
a first sensor scanning part disposed at a first portion of a first side of the first substrate and transmitting a plurality of first sensor scanning signals to the first group of photo-sensors via a plurality of first sensor scanning lines,
a second sensor scanning part disposed at a second portion of the first side of the first substrate and transmitting a plurality of second sensor scanning signals to the second group of photo-sensors via a plurality of second sensor scanning lines, the second portion being adjacent to the first portion; and
a sensor reader part receiving the first, second, third and fourth sensing signals from the photo-sensors via a plurality of first, second, third and fourth sensor signal lines; and
a switching substrate including a plurality of pixel units.

18. The information detecting display device of claim 17, wherein the sensor reader part comprises:
a first sensor reader part disposed at a second side of the first substrate and receiving the first and second sensing signals from the first group of photo-sensors via the first and second sensor signal lines; and
a second sensor reader part disposed at a third side of the first substrate and receiving the third and fourth sensing signals from the second group of photo-sensors via the third and fourth sensor signal lines,
wherein the third side is opposite to the second side.

19. The information detecting display device of claim 17, wherein the sensor reader part comprises:
a first sensor reader part disposed at a first portion of a second side of the first substrate and receiving the first sensing signals from a first sub group of the first group of photo-sensors via the first sensor signal lines;
a second sensor reader part disposed at a second portion of the second side of the first substrate and receiving the second sensing signals from a second sub group of the first group of photo-sensors via the second sensor signal lines;
a third sensor reader part disposed at a first portion of a third side of the first substrate and receiving the third sensing signals from a first sub group of the second group of photo-sensors via the third sensor signal lines; and
a fourth sensor reader part disposed at a second portion of the third side of the first substrate and receiving the fourth sensing signals from a second sub group of the second group of photo-sensors via the fourth sensor signal lines,
wherein the second portion of the second side is adjacent to the first portion of the second side, the second portion of the third side is adjacent to the first portion of the third side, and the second side is opposite to the third side.

20. A method for detecting information in a display device, the method comprising:
generating a plurality of sensing signals by a plurality of photo-sensors arranged in a matrix on a first substrate;
transmitting a plurality of sensor scanning signals from a sensor scanning part to the photo-sensors via a plurality of sensor scanning lines, at least two of the sensor scanning lines transmitting a substantially similar sensor scanning signal simultaneously;
transmitting the sensing signals from the photo-sensors to a sensor reader part via a plurality of sensor signal lines in response to the sensor scanning signals;
processing the sensing signals by the sensor reader part to provide processed sensing signals to a controller; and
determining a position of the sensing signals based on the sensor scanning signals and the sensing signals.
